(19) United States
(12) Patent Application Publication
(10) Pub. No.: US 2021/0182744 A1
(43) Pub. Date: Jun. 17, 2021

(54) REVENUE FORECASTING METHOD, REVENUE FORECASTING SYSTEM AND GRAPHICAL USER INTERFACE

(71) Applicant: INDUSTRIAL TECHNOLOGY RESEARCH INSTITUTE, Hsinchu (TW)

(72) Inventors: Yi-Chun CHEN, Zhubei City (TW); Wen TSUI, Zhubei City (TW)

(73) Assignee: INDUSTRIAL TECHNOLOGY RESEARCH INSTITUTE, Hsinchu (TW)

(21) Appl. No.: 16/715,776

(22) Filed: Dec. 16, 2019

(51) Int. Cl. G06Q 10/04; G06Q 10/02; G06Q 30/02; G06N 7/00; G06F 16/22; G06F 3/0487

(52) U.S. Cl. CPC G06Q 10/04; G06Q 10/02; G06F 3/0487; G06N 7/005; G06F 16/2246; G06Q 30/0206

(57) ABSTRACT

A revenue forecasting method, a revenue forecasting system and a graphical user interface are provided. The revenue forecasting system includes a storage device and a processing device. The processing device includes a pricing tree establishing unit, a generalizing unit, a path establishing unit, a simulation data establishing unit and an estimating unit. The pricing tree establishing unit builds a pricing tree comprising several feature hierarchies, a pricing hierarchy and an order hierarchy according to a target product. The generalizing unit generalizes several pricing nodes according to several target historical orders in the order hierarchy. The path establishing unit generates several pricing paths according to several approximate products. The simulation data establishing unit obtains several simulated historical orders according to a correlation between each of the pricing paths and the pricing tree. The estimating unit analyzes a total revenue with respect to a reservation price using a probability model.

### TECHNICAL FIELD

The disclosure relates in general to a revenue forecasting method, a revenue forecasting system and a graphical user interface.

### BACKGROUND

The environmental factors that need to be considered during the pricing process of product in the pursuit of maximum profit are very complicated. Under several different circumstances, one forecasting model alone could not provide reasonable sufficient information from which the user could form various information required for making decisions.

Traditional sales forecasting needs to consider various factors such as marketing, finance, inventory and logistics. These factors are variable and it is difficult to obtain and analyze data in a real time manner. Unlike weather simulation, business analysis still lacks strong support in terms of expert knowledge and theories and could only use some representative characteristic facts obtained using data driven approach as a basis for simulation. With the development of AIoT, the acquisition of the retailing data of various platforms has been made relatively easier. Therefore, a virtual transaction environment could be established to simulate and test various scenarios, such that the planned marketing strategies could have active forecast function and the strategy failure rate could be reduced.

Based on historical records, the researchers could simulate the sales and prices of one single brand using traditional data simulation technology. However, it the data volume is too small, the simulation result may have a low reliability or simulation may fail. Additionally, since traditional data simulation technology does not consider a competition relationship between commodities/brands/channels, the forecasting of the total revenue has a low accuracy.

### SUMMARY

The disclosure is directed to a revenue forecasting method, a revenue forecasting system and a graphical user interface.

According to one embodiment of the disclosure, a revenue forecasting method is provided. The revenue forecasting method includes the following steps. A pricing tree, comprising several feature hierarchies, a pricing hierarchy and an order hierarchy, is built by a processing device according to a target product, wherein the pricing hierarchy includes several pricing node, the order hierarchy includes several target historical orders, and each of the target historical orders records a purchaser, a purchase quantity and a discount Several pricing nodes are generalize by the processing device according to several target historical orders in the order hierarchy. A number of pricing paths are generated by the processing device according to several approximate products, wherein each of the pricing paths includes the feature hierarchies, the pricing hierarchy and the order hierarchy. Several simulated historical orders are obtained by the processing device at least according to a correlation between each of the pricing paths and the pricing tree. A total revenue with respect to a reservation price is analyzed by the processing device using a probability model according to target historical orders and the simulated historical orders.

According to another embodiment of the disclosure, a revenue forecasting system is provided. The revenue forecasting system includes a storage device and a processing device. The processing device includes a pricing tree establishing unit, a generalizing unit, a path establishing unit, a simulation data establishing unit and an estimating unit. The pricing tree establishing unit is used to build a pricing tree comprising several feature hierarchies, a pricing hierarchy and an order hierarchy according to a target product. The generalizing unit is used to generalize several pricing nodes according to several target historical orders in the order hierarchy. The path establishing unit generates a number of pricing paths according to several approximate products. The simulation data establishing unit is used to obtain several simulated historical orders according to a correlation between each of the pricing paths and the pricing tree. The estimating unit analyzes a total revenue with respect to a reservation price using a probability model.

According to an alternative embodiment of the disclosure, a graphical user interface is provided. The graphical user interface includes a pricing tree display window, a generalization button, a simulated historical order increase button, a reservation price input window and a total revenue display window. The pricing tree display window is used to display a pricing tree. The pricing tree, comprising several feature hierarchies, a pricing hierarchy and an order hierarchy, is obtained according to a target product, wherein the pricing hierarchy includes several pricing node, the order hierarchy includes several target historical orders, and each of the target historical orders records a purchaser, a purchase quantity and a discount. The generalization button is used for a user to click and input a generalization command to generalize several pricing nodes according to several target historical orders in the order hierarchy. The simulated historical order increase button is used for the user to click to generalize a number of pricing paths according to several approximate products and to obtain several simulated historical orders at least according to a correlation between each of the pricing paths and the pricing tree, wherein each of the pricing paths includes the feature hierarchies, the pricing hierarchy and the order hierarchy. The reservation price input window is used for the user to input a reservation price. The total revenue display window is used to display a total revenue with respect to the reservation price, wherein the total revenue is analyzed using a probability model according to the target historical orders and the simulated historical orders.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a revenue forecasting system according to an embodiment.

FIG. 2 is a flowchart of a revenue forecasting method according to an embodiment.

FIG. 3 is an exemplary diagram of step S110.

FIG. 4 is an exemplary diagram of step S120.

FIG. 5 is an exemplary diagram of step S130.

FIG. 6 is another exemplary diagram of step S130.

FIG. 7 is an exemplary diagram of step S140.

FIG. 8 is a schematic diagram of target historical orders and simulated historical orders of an inserted pricing path.

FIG. 9 is a schematic diagram of a graphical user interface according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

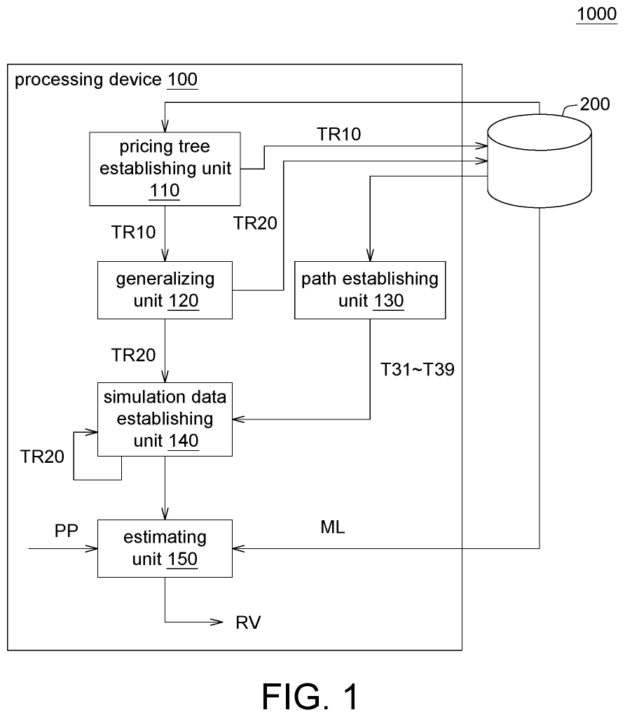

Referring to FIG. 1, a schematic diagram of a revenue forecasting system 1000 according to an embodiment is shown. The revenue forecasting system 1000 includes a processing device 100 and a storage device 200. The processing device 100 includes a pricing tree establishing unit 110, a generalizing unit 120, a path establishing unit 130, a simulation data establishing unit 140 and an estimating unit 150. The pricing tree establishing unit 110, the generalizing unit 120, the path establishing unit 130, the simulation data establishing unit 140 and the estimating unit 150 could be realized by such as a circuit, a chip, a circuit board, several programming codes or a storage device storing programming codes. The storage device 200 could be realized by such as a memory, a hard disc, an optical drive or a clouds data storage center. The pricing tree establishing unit 110 is connected to the storage device 200 and the generalizing unit 120. The generalizing unit 120 is connected to the pricing tree establishing unit 110, the simulation data establishing unit 140 and the storage device 200. The estimating unit 150 is connected to the simulation data establishing unit 140 and the storage device 200. The path establishing unit 130 is connected to the simulation data establishing unit 140 and the storage device 200. The storage device 200 is connected to the pricing tree establishing unit 110, the generalizing unit 120, the path establishing unit 130 and the estimating unit 150. The revenue forecasting system 1000 of the present embodiment could generalize historical data using data generalization technology and could partially insert the data according to a competition relationship between approximate commodities/brands/channels to increase the forecasting accuracy of the total revenue. Operations of above elements are disclosed below with a flowchart.

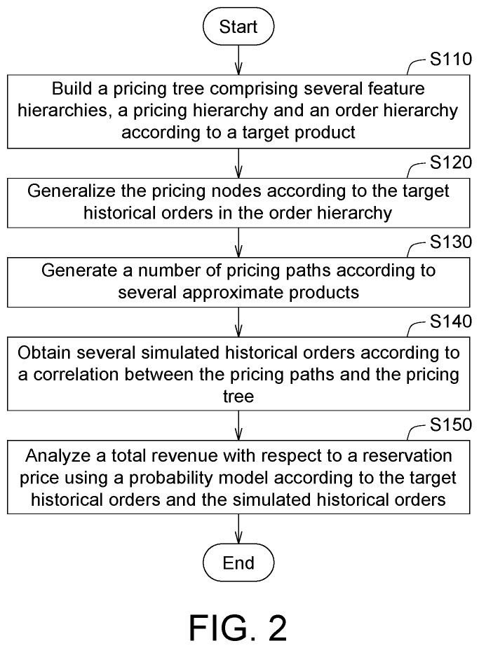

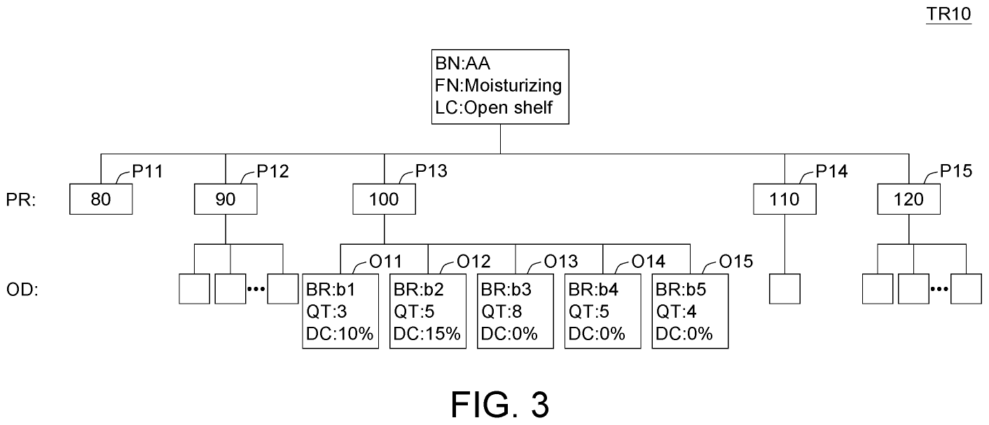

Referring to FIG. 2, a flowchart of a revenue forecasting method according to an embodiment is shown. Firstly, the method begins at step S110, a pricing tree (such as a pricing tree TR10 of FIG. 3) is built by the pricing tree establishing unit 110 according to a target product. The pricing tree TR10 includes several feature hierarchies (such as a brand hierarchy BN, a function hierarchy FN and a positioning hierarchy LC, and the disclosure is not limited thereto; the feature hierarchy could be an age hierarchy or a consumer group hierarchy (such as men, women, young girls, and students)), a pricing hierarchy PR and an order hierarchy OD. Referring to FIG. 3, an exemplary diagram of step S110 is shown. The pricing hierarchy PR includes several pricing nodes P11 to P15, such as “80 dollars”, “90 dollars”, “100 dollars”, “110 dollars” and “120 dollars” respectively. The order hierarchy OD includes several target historical orders. For example, the pricing node P11 does not have any target historical orders, but the pricing node P13 has five target historical orders O11 to O15. Each of the target historical orders O11 to O15 records a purchaser BR, a purchase quantity QT and a discount DC. For example, the purchaser BR, the purchase quantity QT and the discount DC of the target historical order O11 respectively are “b1”, “3”, “10%”; the purchaser BR, the purchase quantity QT and the discount DC of the target historical order O12 respectively are “b2”, “5”, “15%”.

As indicated in the pricing tree TR10 of FIG. 3, the pricing node P11 does not have any target historical orders. The pricing node P11 does not have any historical data, which could be used as a basis for obtaining an approximate simulation order. Therefore, the arrangement of the pricing nodes P11 to P15 of the pricing hierarchy PR needs to be adjusted to ensure that each pricing node has a sufficient quantity of target historical orders.

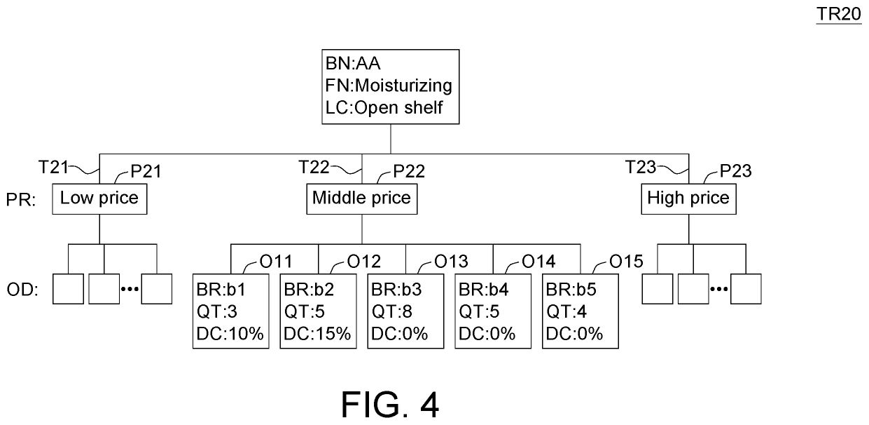

Then, the method proceeds to step S120, the pricing nodes are generalized by the generalizing unit 120 according to the target historical orders in the order hierarchy OD. As indicated in FIG. 3, if the order quantity of one of the pricing nodes P11 to P15 is less than a threshold value (such as 2), then some of the pricing nodes are merged. Referring to FIG. 4, an exemplary diagram of step S120 is shown. In the present step, the order quantity in the pricing node P11 is 0, which is less than 2, therefore the generalizing unit 120 merges the pricing node P11 and the pricing node P12 as a pricing node P21. Since the order quantity in the pricing node P14 is 1, which is less than 2, the generalizing unit 120 merges the pricing node P14 and the pricing node P15 as a pricing node P23. Through data generalization, each of the pricing nodes P21 to P23 of the pricing hierarchy PR will have a sufficient quantity of target historical orders. As indicated in FIGS. 3 to 4, the pricing nodes P11 to P15 of FIG. 3 are generalized as the pricing nodes P21 to P23 of FIG. 4. As indicated in FIG. 4, the pricing nodes P21 to P23 of the pricing tree TR20 respectively are “low price”, “middle price”, and “high price.”

If each of the pricing nodes P21 to P23 has a sufficient quantity of orders, data could be partially inserted through the following steps S120 to S130.

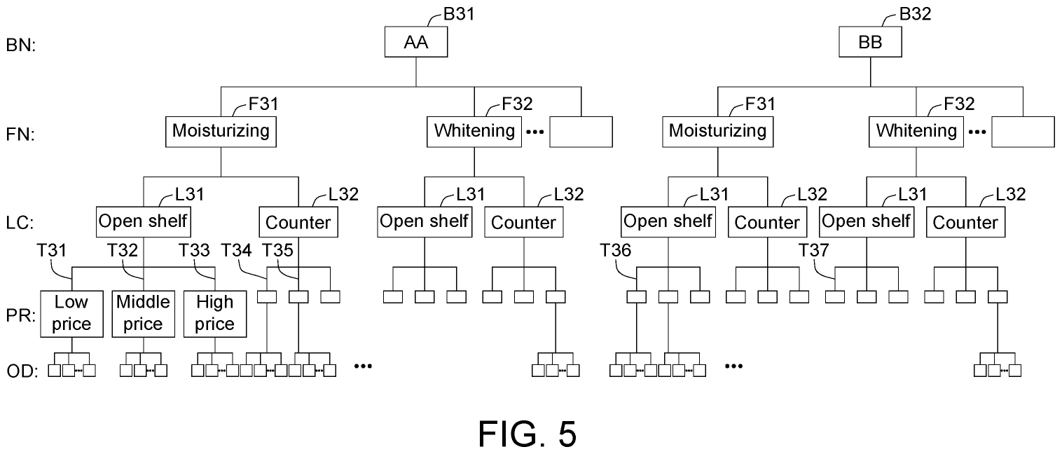

Then, the method proceeds to step S130, a number of pricing paths (such as the pricing paths T31 to T37, etc. of FIG. 5) are generated by the path establishing unit 130 according to several approximate products. Referring to FIG. 5, an exemplary diagram of step S130 is shown. Each of the pricing paths T31 to T37, etc. includes several feature hierarchies (such as the brand hierarchy BN, the function hierarchy FN and the positioning hierarchy LC, but the disclosure is not limited thereto; the feature hierarchy could also be an age hierarchy or a consumer group hierarchy (such as men, women, young girls, and students)), a pricing hierarchy PR and an order hierarchy OD. The brand hierarchy BN includes brand nodes B31 and B32, such as “AA” and “BB” respectively. The function hierarchy FN includes function nodes F31, F32, etc. The function nodes F31 and F32 are such as “moisturizing” and “whitening” respectively. The positioning hierarchy LC includes the positioning nodes L31 and L32, such as “open shelf” and “counter” respectively. As indicated in FIG. 5, the pricing paths T31 to T37, etc. could be established in an order of the brand hierarchy BN, the function hierarchy FN and the positioning hierarchy LC, the pricing hierarchy PR and the order hierarchy OD, wherein, the brand node B31, the function node F31 and the positioning node L31 of the pricing paths T31 to T33, such as “AA”, “moisturizing” and “open shelf” respectively, are identical to the pricing paths T21 to T23 of the pricing tree TR20 of FIG. 4. That is, the content of the order hierarchy OD of the pricing paths T31 to T33 is identical to that of the order hierarchy OD of the pricing paths T21 to T23.

The brand node B31, the function node F31 and the positioning node L32 of the pricing paths T34 are “AA”, “moisturizing”, and “counter” respectively. The brand node B31, the function node F31 and the positioning node L32 of the pricing paths T35 are “AA”, “moisturizing” and “counter” respectively. The brand node B32, the function node F31 and the positioning node L31 of the pricing paths T36 are “BB”, “moisturizing” and “open shelf” respectively. The brand node B32, the function node F32 and the positioning node L31 of the pricing paths T37 are “BB”, “whitening” and “open shelf” respectively. The content of the pricing paths T34 to T37, etc. of the feature hierarchy is different from the content of the feature hierarchy of the pricing paths T21 to T23 of the pricing tree TR20 of FIG. 4. The pricing paths T34 to T37, etc. represent a competition relationship between commodities/brands/channels. The pricing paths approximate to the pricing paths T21 to T23 could be located from the pricing paths T34 to T37, etc. according to the content of the order hierarchy OD. The data of the approximate pricing paths are valuable, and could be added to the pricing tree TR20 to increase the forecasting accuracy of the total revenue.

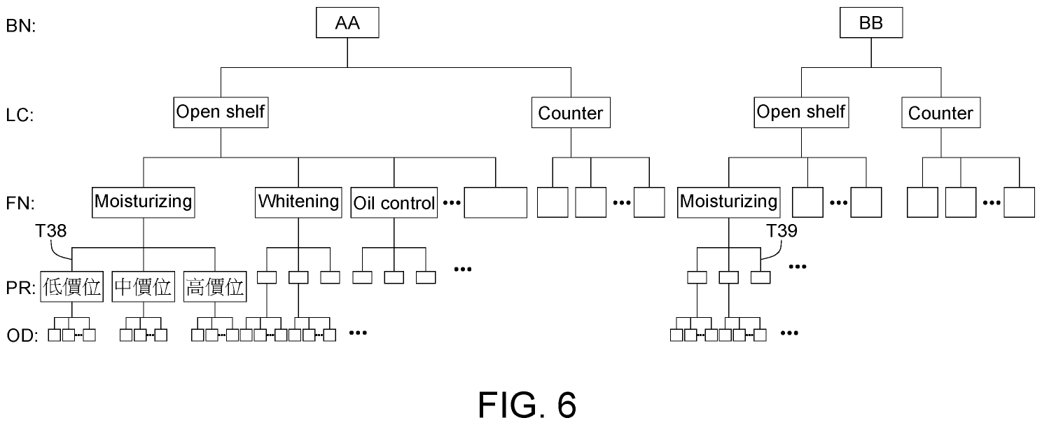

Various pricing paths could be established according to different arrangement orders of the brand hierarchy BN, the function hierarchy FN and the positioning hierarchy LC. Referring to FIG. 6, another exemplary diagram of step S130 is shown. Other pricing paths T38, T39, etc. could be obtained according to another arrangement order. The pricing paths T38, T39, etc. are established according to the arrangement order of the brand hierarchy BN, the positioning hierarchy LC and the function hierarchy FN. Similarly, the pricing paths T38, T39, etc. represent a competition relationship between commodities/brands/channels.

Among the several pricing paths T34 to T39, etc. generated in step S130, the arrangement of the feature hierarchies of the pricing paths T34 to T39, etc. are note identical. Moreover, the content of the feature hierarchy of each of the pricing paths T34 to T39, etc. is not identical to that of the feature hierarchy of the pricing tree for the target product. For example, the content of the feature hierarchy of the pricing path T34 is: “‘AA’, ‘moisturizing’ and ‘counter’”; the content of the feature hierarchy of the pricing path T36: “‘BB’, ‘moisturizing’ and ‘open shelf’”; the content of the feature hierarchy of the target product is: “‘AA’, ‘moisturizing’ and ‘open shelf’”. The content of the feature hierarchy of the pricing path T34 is not identical to that of the feature hierarchy of the pricing tree for the target product; the content of the feature hierarchy of the pricing path T36 is not identical to that of the feature hierarchy of the pricing tree for the target product.

The pricing paths approximate to the pricing paths T21 to T23 could be located from the pricing paths T34 to T37, etc. according to the content of the order hierarchy OD. The data of the approximate pricing paths are valuable, and could be added to the pricing tree TR20 to increase the forecasting accuracy of the total revenue.

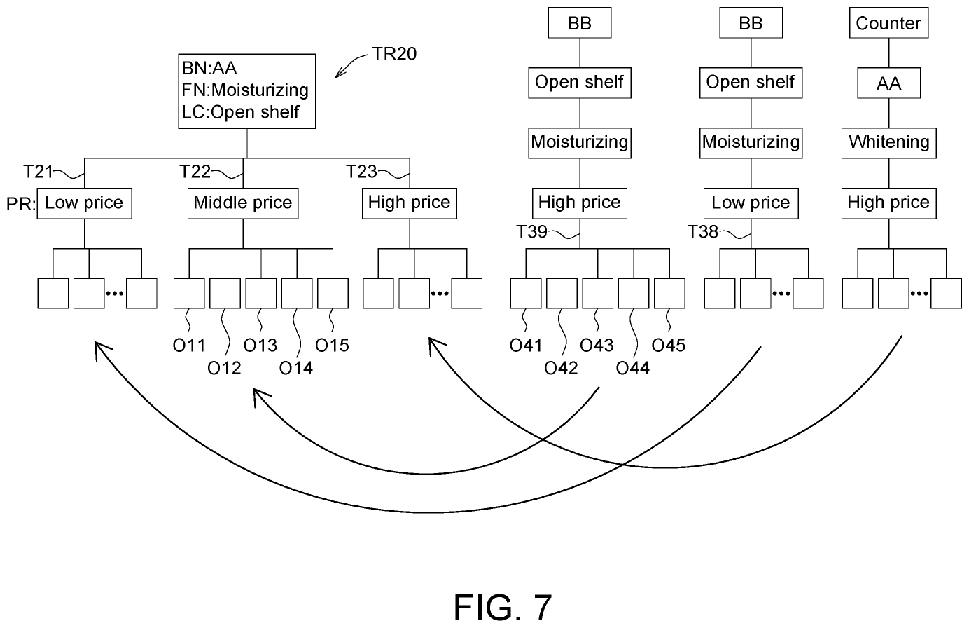

Then, the method proceeds to step S140, several simulated historical orders are obtained by the simulation data establishing unit 140 according to a correlation between each of the pricing paths and the pricing tree (for example, the simulated historical orders O41 to O45 of FIG. 7 could be obtained according to the correlation between the pricing path T39 of FIG. 6 and the pricing path T22 of the pricing tree TR20 of FIG. 4). Referring to FIG. 7, an exemplary diagram of step S140 is shown. In the present step, the simulation data establishing unit 140 firstly calculates the correlation between the one of the pricing paths T34 to T39, etc. with largest data volume and the pricing path T21, the pricing path T22 or the pricing path T23 according to the content of the order hierarchy OD of the one of the pricing paths T34 to T39, etc. with largest data volume. If the correlation is higher than a predetermined value, then the content of the order hierarchy could be regarded as simulated historical orders.

The correlation between two pricing paths could be represented by the Pearson correlation coefficient, which is calculated according to the frequency at which the commodity on the two pricing paths is purchased. The calculation of correlation is expressed as formula (1).

$${ρ}_{X , Y} = \frac{Cov ( X , Y )}{\sqrt{Var ( X ) \cdot Var ( Y )}} = \frac{{S}_{X ⋃ Y} - {S}_{X} {S}_{Y}}{\sqrt{{S}_{X} ( 1 - {S}_{X} ) {S}_{Y} ( 1 - {S}_{Y} )}} \qquad ( 1 )$$

Wherein, ρ_{X,Y} represents the correlation between two pricing paths “X” and “Y”; Cov(X,Y) represents the variance between the pricing path “X” and the pricing path “Y”; Var(X) represents the variance of the pricing path “X”; Var(Y) represents the variance of the pricing path “Y”; S_{X∪Y} represents the frequency at which the commodity on the pricing path “X” and the commodity on the pricing path “Y” are purchased together; S_{X} represents the frequency at which the commodity on the pricing path “X” is purchased; S_{Y} represents the frequency at which the commodity on the pricing path “Y” is purchased.

In an embodiment, the commodity on the pricing path T22 is purchased for 30 times, the commodity on the pricing path T37 is purchased for 50 times, the two commodities are purchased together for 25 times, and in the database, the total purchase times of commodities is 100 times. Therefore, the correlation between the pricing path T22 and the pricing path 37 is calculated as:

$$\frac{\frac{25}{100} - \frac{30}{100} \times \frac{50}{100}}{\sqrt{\frac{30}{100} ( 1 - \frac{30}{100} ) \frac{50}{100} ( 1 - \frac{50}{100} )}} = 0.436 .$$

In another embodiment, suppose the commodity on the pricing path T22 is purchased for 40 times, the commodity on the pricing path T39 is purchased for 50 times, the two commodities are purchased together for 30 times, and in the database, the total purchase times of commodities is 150 times. Therefore, the correlation between the pricing path T22 and the pricing path T39 is calculated as:

$$\frac{\frac{30}{150} - \frac{40}{150} \times \frac{50}{150}}{\sqrt{\frac{40}{150} ( 1 - \frac{40}{150} ) \frac{50}{150} ( 1 - \frac{50}{150} )}} = 0.532 .$$

The correlation between the pricing path T22 and the pricing path T39 is higher than the correlation between the pricing path T22 and the pricing path 37.

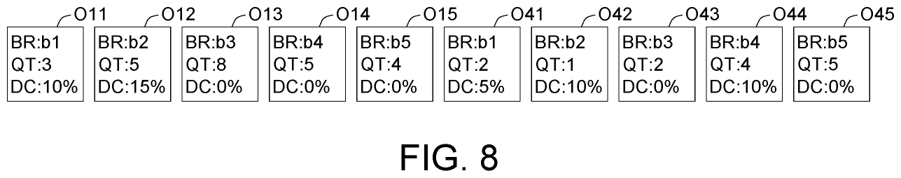

As indicated in FIG. 7, the content of the order hierarchy OD of the pricing path T39 is highly correlated with the pricing path T22, therefore the content of the order hierarchy OD of the pricing path T39 could be regarded as simulated historical orders O41 to O45. The simulated historical orders O41 to O45 could be added to the target historical orders O11 to O15 of the pricing path T22 to partially insert the pricing tree TR20. Referring to FIG. 8, a schematic diagram of target historical orders O11 to O15 and simulated historical orders O41 to O45 of an inserted pricing path T22 is shown.

After the pricing tree TR20 is partially inserted in steps S130 and S140, the data volume of the pricing tree TR20 could be greatly increased to increase the forecasting accuracy of the total revenue.

Then, the method proceeds to step S150, a total revenue with respect to a reservation price is analyzed by the estimating unit 150 using a probability model according to the target historical orders and the simulated historical orders. For example, the total revenue RV with respect to the reservation price PP is analyzed using the probability model ML of FIG. 1 according to the target historical orders O11 to O15 and the simulated historical orders O41 to O45 of FIG. 8.

For example, when the reservation price PP is 130 dollars, the probability model ML is illustrated in Table 1. When the reservation price PP is much higher than the original pricing node, the purchaser has a lower transfer probability; when the reservation price PP is slightly higher than the original pricing node or the reservation price PP is less than the original pricing node, the purchaser has a higher transfer probability. Under the circumstance of the price difference being the same, different purchasers have different transfer probabilities. The transfer probability could be calculated according to the market ratio of the product or could be determined according to the purchaser's preference of commodities shown in previous purchase records.

TABLE 1

| Purchaser | | b1 | b2 | b3 | b4 | b5 |
|---|---|---|---|---|---|---|
| Transfer probability for 130 | | 20% | 10% | 50% | 30% | 40% |
| dollars | | | | | | |
| Target | Purchase | 3 | 5 | 8 | 5 | 4 |
| historical | quantity QT | | | | | |
| Orders O11 to | Discount DC | 10% | 15% | 0% | 0% | 5% |
| O15 | | | | | | |
| Simulated | Purchase | 2 | 1 | 2 | 4 | 5 |
| historical | quantity QT | | | | | |
| orders O41 to | Discount DC | 5% | 10% | 0% | 10% | 0% |
| O45 | | | | | | |

Based on the probability model ML of Table 1, the total revenue RV with respect to the reservation price of 130 dollars is calculated as: “(3*90%*20%*$130+3*90%*80%*$110)+(5*85%*10%*$130+5*85%*90%*$110)+(8*110%*50%*$130+8*110%*50%*$110)+(5*110%*30%*$130+5*110%*70%*$110)+(4*95%*40%*$130+4*95%*60%*$110)+(2*95%*20%*$130+2*95%*80%*$110)+(1*90%*10%*$130+1*90%*90%*$110)+(2*110%*50%*$130+2*110%*50%*$110)+(4*90%*30%*$130+4*90%*70%*$110)+(5*110%*40%*$130+5*110%*60%*$110)=3967.5”

Thus, respective total revenues could be estimated with respect to various reservation prices PP for the decision maker to decide a best reservation price PP. The total revenue is estimated with respect to the reservation price PP. Since the transfer probability is different for each purchaser, the estimated total revenue is different in each time of estimation. After all total revenues are obtained, a mean value could be obtained from the highest and the lowest total revenues.

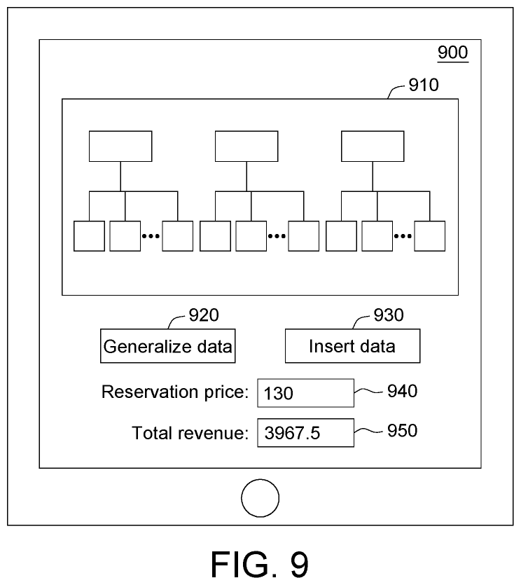

Referring to FIG. 9, a schematic diagram of a graphical user interface 900 according to an embodiment is shown. The graphical user interface 900 is such as a screen displayed on a desktop, a smartphone or a tablet. The graphical user interface 900 includes a pricing tree display window 910, a generalization button 920, a simulated historical order increase button 930, a reservation price input window 940 and a total revenue display window 950.

The pricing tree display window 910 is used to display the pricing tree TR10 disclosed above. The generalization button 920 is used for a user to click and input a generalization command to generalize data. After the data are generalized, the pricing tree TR20 will be displayed on the pricing tree display window 910.

The simulated historical order increase button 930 is used for the user to click and to obtain several simulated historical orders (such as the simulated historical orders O41 to O45 of FIG. 7) according to steps S130 and S140.

The reservation price input window 940 is used for the user to input the reservation price (such as 130 dollars). The total revenue display window 950 is used to display the total revenue RV (such as 3967.5 dollars) with respect to the reservation price PP.

According to the above embodiments, the revenue forecasting system 1000 could generalize historical data using data generalization technology and could partially insert the data according to a competition relationship between approximate commodities/brands/channels to increase the forecasting accuracy of the total revenue RV.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A revenue forecasting method, comprising:
building, by a processing device, a pricing tree comprising a plurality of feature hierarchies, a pricing hierarchy and an order hierarchy according to a target product, wherein the pricing hierarchy comprises a plurality of pricing nodes, the order hierarchy comprises a plurality of target historical orders, and each of the target historical orders records a purchaser, a purchase quantity and a discount;
generalizing the pricing nodes by the processing device according to the target historical orders in the order hierarchy;
generating a plurality of pricing paths according to a plurality of approximate products by the processing device, wherein each of the pricing paths comprises the feature hierarchies, the pricing hierarchy and the order hierarchy;
obtaining a plurality of simulated historical orders by the processing device at least according to a correlation between each of the pricing paths and the pricing tree; and
analyzing a total revenue with respect to a reservation price by the processing device using a probability model according to the target historical orders and the simulated historical orders.

2. The revenue forecasting method according to claim 1, wherein in the step of generalizing the pricing nodes, if order quantity of one of the pricing nodes is less than a threshold value, then some of the pricing nodes are merged.

3. The revenue forecasting method according to claim 1, wherein in the step of generating the pricing paths, arrangements of the feature hierarchies of the pricing paths are not identical.

4. The revenue forecasting method according to claim 1, wherein in the step of generating the pricing paths, content of the feature hierarchies of the pricing paths is not identical to that of the feature hierarchies of the pricing tree for the target product.

5. The revenue forecasting method according to claim 1, wherein in the step of obtain a plurality of simulated historical orders, the correlation relates to a relevance between content of the order hierarchy of each of the pricing paths and the target historical orders corresponding to one of the pricing nodes of the pricing tree.

6. The revenue forecasting method according to claim 1, wherein in the step of obtaining the simulated historical orders, the simulated historical orders are obtained according to data volume of the order hierarchy of each of the pricing paths.

7. The revenue forecasting method according to claim 1, wherein in the step of analyzing the total revenue with respect to the reservation price, the probability model represents a transfer probability of each purchaser based on the reservation price.

8. The revenue forecasting method according to claim 1, wherein the feature hierarchies of each of the pricing paths comprise brand, function and positioning.

9. A revenue forecasting system, comprising:
a storage device; and
a processing device connected to the storage device, wherein the processing device comprises:
a pricing tree establishing unit used to build a pricing tree comprising a plurality of feature hierarchies, a pricing hierarchy and an order hierarchy according to a target product, wherein the pricing hierarchy comprises a plurality of pricing nodes, the order hierarchy comprises a plurality of target historical orders, each of the target historical orders records a purchaser, a purchase quantity and a discount, and the pricing tree is stored in the storage device;
a generalizing unit used to generalize the pricing nodes according to the target historical orders in the order hierarchy;
a path establishing unit used to generates a plurality of pricing paths according to a plurality of approximate products, wherein each of the pricing paths comprises the feature hierarchies, the pricing hierarchy and the order hierarchy;
a simulation data establishing unit used to obtain a plurality of simulated historical orders at least according to a correlation between each of the pricing paths and the pricing tree; and
an estimating unit used to analyze a total revenue with respect to a reservation price using a probability model according to the target historical orders and the simulated historical orders.

10. The revenue forecasting system according to claim 9, wherein if order quantity of one of the pricing nodes is less than a threshold value, then the generalizing unit merges some of the pricing nodes.

11. The revenue forecasting system according to claim 9, wherein arrangements of the feature hierarchies of the pricing paths are not identical.

12. The revenue forecasting system according to claim 9, wherein content of the feature hierarchies of the pricing paths is not identical to that of the feature hierarchies of the pricing tree for the target product.

13. The revenue forecasting system according to claim 9, wherein the correlation relates to a relevance between content of the order hierarchy of each of the pricing paths and the target historical orders corresponding to one of the pricing nodes of the pricing tree.

14. The revenue forecasting system according to claim 9, wherein the simulation data establishing unit further obtains the simulated historical orders according to data volume of the order hierarchy of each of the pricing paths.

15. The revenue forecasting system according to claim 9, wherein the probability model represents a transfer probability of each purchaser based on the reservation price.

16. The revenue forecasting system according to claim 9, wherein the feature hierarchies of each of the pricing paths comprise brand, function and positioning.

17. A graphical user interface, comprising:
a pricing tree display window used to display a pricing tree comprising a plurality of feature hierarchies, a pricing hierarchy and an order hierarchy according to a target product, wherein the pricing hierarchy comprises a plurality of pricing nodes, the order hierarchy comprises a plurality of target historical orders, and each of the target historical orders records a purchaser, a purchase quantity and a discount;
a generalization button used for a user to click and input a generalization command to generalize the pricing nodes according to the target historical orders in the order hierarchy;
a simulated historical order increase button used for the user to click to generate a plurality of pricing paths according to a plurality of approximate products and to obtain a plurality of simulated historical orders at least according to a correlation between each of the pricing paths and the pricing tree, wherein each of the pricing paths comprises the feature hierarchies, the pricing hierarchy and the order hierarchy;
a reservation price input window used for the user to input a reservation price; and
a total revenue display window used to display a total revenue with respect to the reservation price, wherein the total revenue is analyzed using a probability model according to the target historical orders and the simulated historical orders.

18. The graphical user interface according to claim 17, after one of the generalization button is clicked, if order quantity of one of the pricing nodes is less than a threshold value, then some of the pricing nodes are merged.

19. The graphical user interface according to claim 17, wherein in the pricing paths display window, arrangements of the feature hierarchies of the pricing paths are not identical.

20. The graphical user interface according to claim 17, wherein in the pricing paths display window, content of each of the feature hierarchies of the pricing paths is not identical to that of the feature hierarchies of the pricing tree for the target product.

21. The graphical user interface according to claim 17, wherein in the pricing paths display window, the feature hierarchies of each of the pricing paths comprise brand, function and positioning.
